(19) United States
(12) Patent Application Publication
(10) Pub. No.: US 2017/0129213 A1
(43) Pub. Date: May 11, 2017

(54) CONSTRUCTION ELEMENT

(71) Applicants: ThyssenKrupp Steel Europe AG, Duisburg (DE); ThyssenKrupp AG, Essen (DE)

(72) Inventors: Peter Klauke, Schwerte (DE); Oliver Kleinschmidt, Dortmund (DE); Tobias Lewe, Münster (DE)

(73) Assignees: ThyssenKrupp Steel Europe AG, Duisburg (DE); ThyssenKrupp AG, Essen (DE)

(21) Appl. No.: 15/309,738

(22) PCT Filed: May 4, 2015
(86) PCT No.: PCT/EP2015/059700

§ 371 Date: Nov. 8, 2016

(30) Foreign Application Priority Data
May 15, 2014 (DE) 10 2014 007 066.2

(51) Int. Cl. B32B 15/04; E04C 2/08; E04C 2/34; B32B 3/26

(52) U.S. Cl. CPC B32B 15/04; B32B 3/266; E04C 2/08; E04C 2/34; B32B 2309/105

(57) ABSTRACT

A construction element may include two metallic covering layers and a non-metallic core layer arranged between the two metallic covering layers. The non-metallic core layer between the two metallic covering layers may be formed from a silicone-containing material that includes deoxidative elements and/or deoxidative alloys that are dispersed in an amount of between 0.1 and not more than 5% by weight based on the non-metallic core layer. Some example deoxidative elements include Ca, Mg, Al, Ti, Si, Mn, Cr, Ce, La, Nb, Ta, V, and Zn. Some example deoxidative alloys include ferrosilicon, ferrocalcium silicon, or ferromanganese. The construction element is suitable for, amongst other things, fusion welding and/or hot-soldering.

The invention relates to a construction element consisting of two metallic covering layers and a non-metallic core layer arranged between the covering layers.

Construction elements of the generic type are known from the prior art. The structure-borne sound insulating composite material marketed by the applicant under the trade name Bondal® consists of two steel covering sheets and a viscoelastic plastics core layer arranged therebetween, wherein the core layer consists of an acrylate or polyester material. Joining the structure-borne sound insulating composite material to other components, for example by welding, in particular resistance welding, generally does not represent a problem. In order to increase the suitability of a structure-borne sound insulating composite material for resistance welding, it is possible, as disclosed in patent specification DE 38 34 829 C2, to add to the plastics core layer welding additives in the form of ferrosilicon powder having a particle size of from 70 to 130% of the thickness of the plastics layer. Fusion welding or even hot-soldering cannot be used in the case of such construction elements because thermal decomposition reactions occur at temperatures of above 250° C. in the region of the joining seam as a whole and also in parts of the heat-affected zone. In addition to numerous combustion residues, quantities of gases, mainly carbon dioxide, are formed in fusion welding as a result of the action of heat, which prevents pore-free setting of the molten phase.

Starting therefrom, the object of the present invention is to propose a construction element which is suitable for fusion welding and/or hot-soldering.

The stated object for a construction element of the generic type is achieved in that the non-metallic core layer is formed of a silicone-containing material and the silicone-containing core layer comprises deoxidative elements and/or deoxidative alloys which are dispersed in the silicone-containing core layer in an amount of from 0.1% by weight to a maximum of 5% by weight, based on the core layer.

Tests have shown that silicone-containing materials are able to withstand temperatures of up to 800° C. for a short time. At higher temperatures, as are conventional in MIG and MAG welding, the silicon in the silicone-containing material decomposes in an oxygen-containing atmosphere to silicon dioxide because of its high affinity for oxygen. As a result of the reaction of the silicon with the oxygen, the outgassing of the molten metal and pore formation in the region of the joining seam are significantly reduced. The silicon dioxide formed is deposited in the form of a silicate on the surface of the joining seam (surface of the weld seam) and can be removed mechanically if required. After addition of deoxidative elements and/or deoxidative alloys to the silicone-containing core layer, it has surprisingly been found that, during the joining process (fusion welding process), oxygen is bound and either transferred to the slag via the weld melt or deposited in the melt in the form of finely divided, non-metallic inclusions (NME) in the course of a so-called precipitation oxidation, so that pore-free setting is possible. When combined with the metallic covering layers, construction elements according to the invention have structure-borne sound insulating properties and can thus be made available for structures preferably in the maritime industry, such as, for example, in shipbuilding or alternatively in railway transportation, in vehicle and aircraft construction, the armament industry, power plant construction, steel structural engineering and in all fields in which joints are produced by hot-soldering and/or fusion welding.

According to the invention, the deoxidative elements and/or deoxidative alloys are dispersed in the silicone-containing core layer in an amount of between 0.1 and not more than 5% by weight, based on the core layer. In order to ensure sufficient adhesion between the metallic covering layers, the amount of the deoxidative elements and/or alloys is limited to a maximum of 5% by weight, in particular to a maximum of 3% by weight and preferably to a maximum of 1.5% by weight. In order to promote oxygen binding during the joining process, the amount of the deoxidative elements and/or deoxidative alloys is at least 0.1% by weight, in particular at least 0.2% by weight and preferably at least 0.25% by weight. Suitable deoxidative elements are, for example, Ca, Mg, Al, Ti, Si, Mn, Cr, Ce, La, Nb, Ta, V and/or Zn in the form of powders and/or flakes. The above-mentioned elements can be added to the silicone-containing core layer either individually or in combination, in particular also with other deoxidative elements and/or deoxidative alloys such as, for example, ferrosilicon (FeSi), ferrocalcium silicon (Fe-Ca-Si), ferromanganese (FeMn).

A further embodiment of the invention provides that the metallic covering layers are formed of a steel material. Metallic coated or uncoated steel materials, for example construction steels, are relatively inexpensive and are therefore outstandingly suitable for structures preferably in shipbuilding or mechanical engineering. Light metal materials such as aluminum and magnesium materials can also be used as metallic covering layers if additional weight in the construction element is to be saved, as well as in combination with a steel material. The metallic covering layers have a thickness of from 0.2 to 30 mm, in particular from 0.5 to 10 mm, preferably from 1 to 10 mm and particularly preferably from 1.5 to 5 mm.

In combination with the silicone-containing core layer, which has a thickness of from 0.01 to 0.2 mm, in particular from 0.02 to 0.1 mm and preferably from 0.025 to 0.05 mm, an inexpensive construction element can be provided. The silicone-containing core layer can be introduced in the form of a foil, preferably as an adhesive foil between the metallic covering layers.

In a first embodiment, a construction element according to the invention, which consisted of uncoated steel covering layers of grade S235JR+AR (according to EN 10025-2:2004-10) each having a thickness of 3.5 mm and an intermediate silicone-containing adhesive layer (FT 3102, Avery Dennison) having a thickness of 0.05 mm and dispersed aluminum flakes (RO 500, Eckart) in an amount of 0.75% by weight, was welded by means of MAG fusion welding in the T-joint to a carrier of a monolithic steel material. The fusion weld seam did not indicate pores or cavities. Such fusion-welded structures are to be found in shipbuilding and mechanical engineering.

In a second embodiment, a construction element according to the invention having the same composition as in the first embodiment was chosen, except that the dimensions of the construction element were 1000×600 mm and holes/bores had been introduced into a steel covering layer, for example in the middle and in the region of the corners of the construction element. The core layer was exposed in those discrete regions. The holes were filled by means of MAG fusion welding. The fusion-welded joint in point form between the two steel covering sheets was pore- and cavity-free. The risk of delamination, for example during transportation and on loading, in particular by means of a magnet crane, was thus suppressed. As a result, however, even in the fitted state, premature delamination, for example in the event of fire, can be prevented.

1-5. (canceled)

6. A construction element comprising:
two metallic covering layers; and
a non-metallic core layer disposed between the two metallic covering layers, wherein the non-metallic core layer is comprised of a silicone-containing material, wherein the silicone-containing non-metallic core layer comprises at least one of deoxidative elements or deoxidative alloys that are dispersed in an amount of between 0.1 and not more than 5% by weight based on the non-metallic core layer.

7. The construction element of claim 6 wherein the at least one of the deoxidative elements or the deoxidative alloys are dispersed in the silicone-containing non-metallic core layer in the amount of between 0.1 and not more than 3% by weight based on the non-metallic core layer.

8. The construction element of claim 6 wherein the at least one of the deoxidative elements or the deoxidative alloys are dispersed in the silicone-containing non-metallic core layer in the amount of between 0.1 and not more than 1.5% by weight based on the non-metallic core layer.

9. The construction element of claim 6 wherein the two metallic covering layers are comprised of at least one of a steel material, an aluminum material, or a magnesium material, wherein the at least one of the steel material, the aluminum material, or the magnesium material is either metallic coated or uncoated.

10. The construction element of claim 6 wherein the two metallic covering layers have a thickness of 0.2 to 30 mm.

11. The construction element of claim 6 wherein the two metallic covering layers have a thickness of 0.5 to 15 mm.

12. The construction element of claim 6 wherein the two metallic covering layers have a thickness of 1 to 10 mm.

13. The construction element of claim 6 wherein the two metallic covering layers have a thickness of 1.5 to 5 mm.

14. The construction element of claim 6 wherein the silicone-containing non-metallic core layer has a thickness of 0.01 to 0.2 mm.

15. The construction element of claim 6 wherein the silicone-containing non-metallic core layer has a thickness of 0.02 to 0.1 mm.

16. The construction element of claim 6 wherein the silicone-containing non-metallic core layer has a thickness of 0.025 to 0.05 mm.

17. A fusion-welded structure in at least one of a maritime industry, railway transportation, vehicle and aircraft construction, an armament industry, power plant construction, or steel structural engineering that has at least one construction element as recited in claim 6.

18. The construction element of claim 6 wherein the at least one of the deoxidative elements or the deoxidative alloys comprise at least one of Ca, Mg, Al, Ti, Si, Mn, Cr, Ce, La, Nb, Ta, V, or Zn.

19. The construction element of claim 18 wherein the at least one of Ca, Mg, Al, Ti, Si, Mn, Cr, Ce, La, Nb, Ta, V, or Zn is in a form of flakes or powders.

20. The construction element of claim 6 wherein the at least one of the deoxidative elements or the deoxidative alloys comprises at least one of ferrosilicon, ferrocalcium silicon, or ferromanganese.

21. The construction element of claim 6 wherein at least one of the two metallic covering layers includes a hole or a bore.
